(19) United States
(12) Patent Application Publication
(10) Pub. No.: US 2011/0200980 A1
(43) Pub. Date: Aug. 18, 2011

(54) INFORMATION PROCESSING DEVICE OPERATION CONTROL SYSTEM AND OPERATION CONTROL METHOD

(75) Inventors: Hiroyuki Takahashi, Shinjuku-ku (JP); Shugo Takahashi, Shinjuku-ku (JP); Shuji Shimizu, Shinjuku-ku (JP); Kentaro Sako, Shinjuku-ku (JP); Norisumi Osawa, Shinjuku-ku (JP)

(73) Assignee: CAMELOT CO., LTD., Shinjuku-ku, Tokyo (JP)

(21) Appl. No.: 13/125,002

(22) PCT Filed: Oct. 20, 2009
(86) PCT No.: PCT/JP2009/068077

§ 371 Date: Apr. 19, 2011

(30) Foreign Application Priority Data
Oct. 20, 2008 (JP) 2008-270369

(51) Int. Cl. G09B 25/00

(52) U.S. Cl. 434/365

(57) ABSTRACT

Provided is an information processing device operation control system which records an operation history of a function module; analyzes the operation history; extracts a reserved function module; references tutorial information according to the extracted reserved function module; acquires a tutorial of the reserved function module; adds to schedule information, the type of the plan content based on the position information, the time information, and the use example contained in the tutorial information, as a user plan; and reports the use example of a plurality of function modules according to the schedule information, so as to start a tutorial.

### TECHNICAL FIELD

Present invention relates to an operation control system and an operation control method, for information processing equipments which has a plurality of functional modules, such as a portable telephone terminal or PDA (Personal Digital Assistance).

### BACKGROUND ART

These years, while mobile terminal equipments, such as the mobile phone for telecommunication by wireless communications, have been spread the mobile terminal equipments have evolved, in order to have not only a call function but various functions, such as a transmitting function of e-mail, a digital camera function, a music reproduction function, a television reception function, and a schedule management function.

Even though convenience of mobile terminals is rising by this multi-functionalization, as a result, in order that manipulations of equipment are complicated, it is difficult to master all the functions.

Moreover, even though we have instruction handbooks for explaining the manipulations, the books get huge volume. Therefore, it is difficult to read through the instruction handbook or to find out an answer for the question. In particular, about the mobile phone, since the user attained to the wide age group, it is difficult for old generations' user to use various functions.

As an art for these subjects, a system is suggested which user can use voice guidance of operator by calling to a guidance center of cell phone service, with pushing help buttons on the mobile phone (patent Literature 1),

### CITATION LIST

### Patent Literature

[Patent Literature 1]
JP, 2002-142028, A

### SUMMARY OF INVENTION

### Technical Problem

However, as for the above patent documents 1, Even though it can solve the question of the operation method or the function of the mobile terminal by direct guidance of the operator, it never guides about the unknown function for the user. Particularly, since the old generations' user doesn't know what kind of function it has, there was the subject that they had a lot of unused function.

The present invention has been made in order to solve the problems as described above, about multifunctional information processing equipment, it is an object to provide a operation control system and a operation control method can urge users to use system function to the full, by notice and operation guide using tutorials for the unused function,

### Solution to Problem

In order to accomplish the object as described above, the present invention provides

an operation control system for information processing equipments with a plurality of functional modules comprising:
a clock unit for acquiring current time information;
an operation history recording unit for recording operation history of the functional modules;
a tutorial storage unit for memorizing information about an example of how to use the functional modules as a tutorial information related with a time information;
an operation history analyzing unit for extracting unused functional modules by analyzing the operation history;
a tutorial receiving unit for acquiring the example of how to use the unused functional modules with referring to the tutorial information based on the unused functional modules extracted by the operation history analyzing unit;
a schedule memory unit for storing the time information, and the type of the user's schedule as a schedule information;
a tutorial setting unit for adding the time information and the classification of the contents of the schedule according to the example of how to use, are included in the tutorial information acquired by the tutorial receiving unit to the schedule information as the user's schedule; and
a guide unit for announcing example of how to use for the functional module based on the schedule information.

The other invention provides an operation control method for information processing equipments with a plurality of functional modules comprising:

Previously, memorizing information about an example of how to use the functional modules as a tutorial information related with a position information and a time information, and
(1) an operation history recording step for recording operation history of the functional modules;
(2) an operation history analyzing step for extracting unused functional modules by analyzing the operation history;
(3) a tutorial receiving step for acquiring the example of how to use the unused functional modules with referring to the tutorial information based on the unused functional modules extracted by the operation history analyzing step;
(4) a tutorial setting step for adding the time information and the classification of the contents of the schedule according to the example of how to use, are included in the tutorial information acquired by the tutorial receiving step to the schedule information as the user's schedule; and
(5) a starting tutorial step for announcing example of how to use for the functional module based on the schedule information.

According to these inventions, since the different guidance and operation explanation about unused function for each user are added to the schedule as the information about the example of how to use operation description, the operation lessons of ignorance or the unknown function for the user can be scheduled as the user's plan. As a result, in the suitable time zone, the tutorial mode is started automatically, and he can recommend using the unused function to the user.

Preferably, in accordance with in the above invention, comprising further a position information acquisition unit which acquires the position information which points the own position, wherein the tutorial storage unit memorizes information about the example of how to use for each of the functional module as tutorial information with the time information and the position information; and

wherein the schedule memory unit stores the time information, the position information and the type of the user's schedule as schedule information.

In this case, the tutorial mode suitable for the place can be started automatically by considering own position information.

Preferably, in accordance with in the above invention, wherein the tutorial storage unit and the operation history analyzing unit are provided in the server established on the communication network, and

wherein the tutorial acquisition unit has a communication unit for acquiring examples of how to use for the unused functional module based on the operation history through the communication network.

In this case, since the position information at the time of photography, time information, etc. can be collected on the server using the operation history about the functional module for each user, the information can be analyzed and various examples of how to use of the unused functional module to each user can be set up, thereby it will be possible to provide the example of how to use of the more suitable unused functional module for the user. Moreover, in order to store the analysis of the operation history, and the contents data for the tutorial on the server, the user's burden can be reduced and memory space can be used effectively.

Preferably, in accordance with in the above invention, comprising further a display control unit has a calendar display function with showing the current date,

wherein the calendar display function splits the calendar by the current date, displays a list of the image data stored in the image data accumulating unit in the split part of the past from the current date, and displays schedule information stored in the schedule memory unit in the split part of the future from the current date.

In this case, since the image data for each date can be browsed about the date part before the current date, the time and effort searched from much image data in image data retrieval can be saved, and discovery of the picture made into the purpose can be made easy. Since the action of the user for each date can also be browsed, it is possible to have the function as the diaries. On the other hand, about the date part after the current date, since it is available to record and display the user's schedule, it is possible to have the schedule function as a notebook. And since these displays are unified into the one calendar with dividing line on the current date, the GUI for the diary and the notebook can be summarized to one, the area for the display can be reduced with raising clearness, and the limited area for the display can be utilized effectively.

Preferably, in accordance with in the above invention, comprising further:

a photographing unit for taking pictures as one of the functional modules;
a photographing mode setting unit for setting up photographing modes of photography by the photographing unit;
a photographing condition information receiving unit for acquiring the position information which points the current position, and the current time information as a photographing condition information in an event for taking the pictures;
an additional information processing unit for adding the setting of the photographing mode of the image data, and the photographing condition information to the image data took by the photographing unit as attribution information about the each image data;
an image data accumulating unit for storing the image data with the attribution information added by the additional information processing unit; and
a display control unit for list display of the image data stored in the image data accumulating unit according to the attribution information of each picture,
wherein the operation history recording unit records the history of the operational mode set up by the photographing mode setting unit, with including into the operation history.

In this case, since the photographing mode information at the time of the shot, the own location information, and photographing time information can be added to the image data about the taken picture, the image data can be searched for and displayed order by attribution information of each data according to the additional information, so the burden of classifying of the image data by the user will be reduced. Particularly, since the additional information of the image data is related with operation mode information, position information, and photographing time information, the search and the reading of the image data of it are attained more detailed. And such a function can be urged to use as part of the tutorial at the user.

Preferably, in accordance with in the above invention, comprising further:

a face detection unit for detecting a person's face part, and computing the coordinates position in the base images of this detected face part; and
a face seal generating unit for changing the face part detected by the face detection unit, into the image data of specific shape,
wherein the face detection unit and the face seal generating unit are included in the functional modules,
wherein the photographing mode setting unit, it is selectable a photographing mode including the facial recognition processing by the face detection unit and the conversion process of the image data based on the face seal generating unit, and
wherein the operation history recording unit also records an operation history of photographing mode including the detection processing and the conversion process selected by the photographing mode setting unit, with the operation history.

In this case, the faces of the person in the images taken by the user are detected partially, and since the data can be stored, each user can use the person's face part for various purposes. Further, because photographing mode including the detection processing and the conversion process is also memorized to the photographing setting storage unit, the automatic setup of the photographing mode at the time of photography and the unused tutorial setup are also attained.

### Advantageous Effects of Invention

As has been discussed above, in accordance with the present invention about multifunctional information processing equipment, it is possible to urge users to use system function to the full, by notice and operation guide using tutorials for the unused function. As a result, it is expected that the use user of various contents can be gained newly.

### BRIEF DESCRIPTION OF DRAWINGS

FIG. 1 is a key map showing an entire configuration of an image photographing system concerning an embodiment.

FIG. 2 is a front view showing an appearance of a personal digital assistant concerning the embodiment.

FIG. 3 (a) is a block diagram showing an internal configuration related to a schedule function and tutorial function of the mobile terminal related to the embodiment, and (b) is a block diagram showing modules of the image photographing system in the mobile terminal.

FIG. 4 is a flow chart figure showing operations of a schedule function, and a tutorial function related to the embodiment.

FIG. 5 is an explanatory view showing a display screen of the folder for storing image data concerning the embodiment.

FIG. 6 is an explanatory view showing a display screen of the calendar function concerning the embodiment.

FIG. 7 is an explanatory view showing screen changes of the schedule function concerning the embodiment.

FIG. 8 is an explanatory view showing a screen change of the tutorial function concerning the embodiment.

FIG. 9 is an explanatory view showing other screen changes of the tutorial function concerning the embodiment.

FIG. 10 is an explanatory view of a face seal function related to the embodiment.

FIG. 11 is a flow chart figure showing operations of an image photographing function related to this embodiment.

FIG. 12 is a flow chart figure showing operations of the image composing photographing system concerning the embodiment.

FIG. 13 is an explanatory view showing operation instances of GUI concerning the embodiment.

FIG. 14 is an explanatory view showing other display examples of GUI concerning the embodiment.

### DESCRIPTION OF EMBODIMENTS

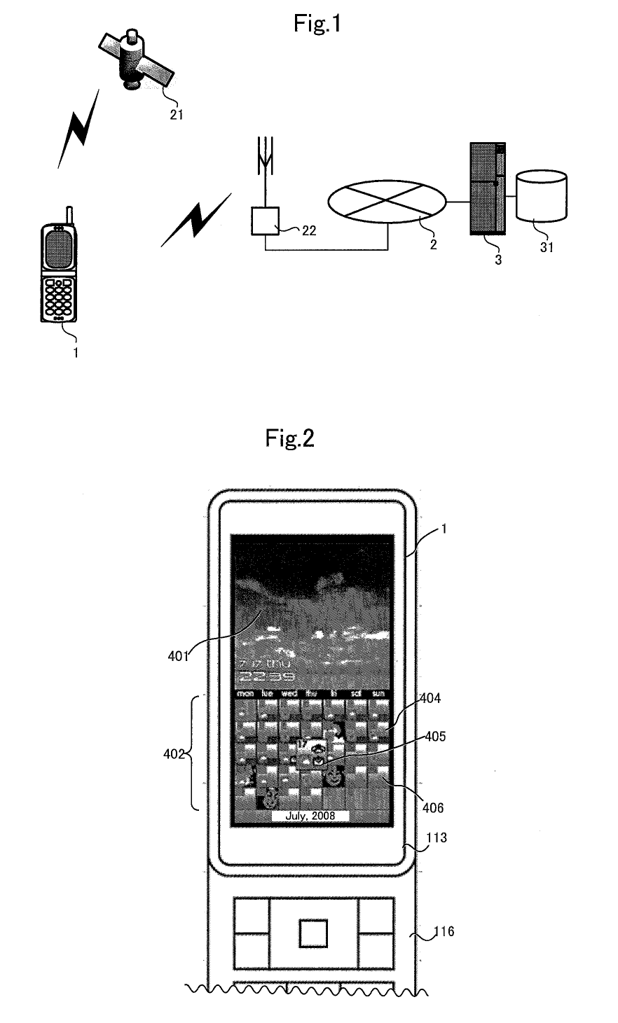

In the following, with reference to the accompanying drawings, an embodiment of the image photographing system related to the present invention will be explained in detail. FIG. 1 is a conceptual diagram showing whole configuration of the image photographing system related to this embodiment, and FIG. 2 is a front view showing an appearance of a personal digital assistant 1.

In this embodiment, the image photographing system comprises personal digital assistants 1 with the camera which the users use, and a contents server 3 located on the Internet 2, as shown in FIG. 1. Moreover, in the case of the present embodiment, the personal digital assistant 1 with a camera is explained as an example of information processing equipment which has a plurality of functional modules.

The contents server 3 is a server which distributes additional contents and tutorial information in the case of the present embodiment, comprises the equipment, such as the Web server, for example. The content server is a document system of the WWW (World Wide Web) or the like, and is implemented as a server computer or software capable of transmitting content such as HTML (HyperText Markup Language) files, image files, music files and the like, and serves to deliver content data accumulated in it through the Internet 2 in response to that request from the personal digital assistants 1.

Moreover, All or some of contents data distributed by this contents server 3 can also be stored in the personal digital assistant 1 by installing in the personal digital assistant 1 previously, even if the personal digital assistant 1 searches for local contents data in itself, when it is not stored locally, it is possible to request distribution of the data to the contents server 3 and to download it.

In addition, the contents server 3 as this data accumulation unit has a regional image storing unit 31 to store, relating contents data such as regional image data with position information, a performs the function as the regional image distribution server which distributes the contents including regional image data unique in each region by limited distribution, the background data of the famous place and special of each region, wallpaper data, the frame, the template such as the “face set-in signboard” of the symbol characters of each region, etc. are contained in the regional image.

Moreover, the “recommended information” which is ranking about the topics (places of interest, the specialty, store information, other news) about the zone, and the map data in addition to the above regional image data is included in unique contents in each of this region.

The personal digital assistant 1 with the camera is a portable telephone uses wireless communications, and communicates by the relay point and radio such as the base station, and can use communications services, such as the phone call and data communications with moving. As a communication mode of this cellular phone, there is the PHS (Personal Handy phone System) method in addition to the FDMA method, the TDMA system, the CDMA system, and W-CDMA etc., for example. This cellular phone has the execution function of application software in addition to the digital camera function, the GPS (Global Positioning System) function, etc., and also performs the function as a Personal Digital Assistant (PDA).

The camera function is a photographing function which photos digital images optically. In addition, the position information acquiring function is the function which acquires and records the position information which points the own position at the time of photography, as this position information acquiring function, as shown in FIG. 1, the way the signal from the satellite 21 detects the own position like GPS, and the way the radio field intensity from the base transceiver station 22 of the mobile phone, etc. detect the current position are used.

And, as shown in FIG. 2, this personal digital assistant 1 is provided with operation device 116 for an alter operation by the users, such as the manual operation button, the jog dial, and the touch panel, and is provided also with the image display part 113, in this image display part 113, a main screen 401 and a calendar UI 402 are displayed as GUI. And particularly, the personal digital assistant 1 is provided with a schedule function and a tutorial function using calendar UI402, in this embodiment.

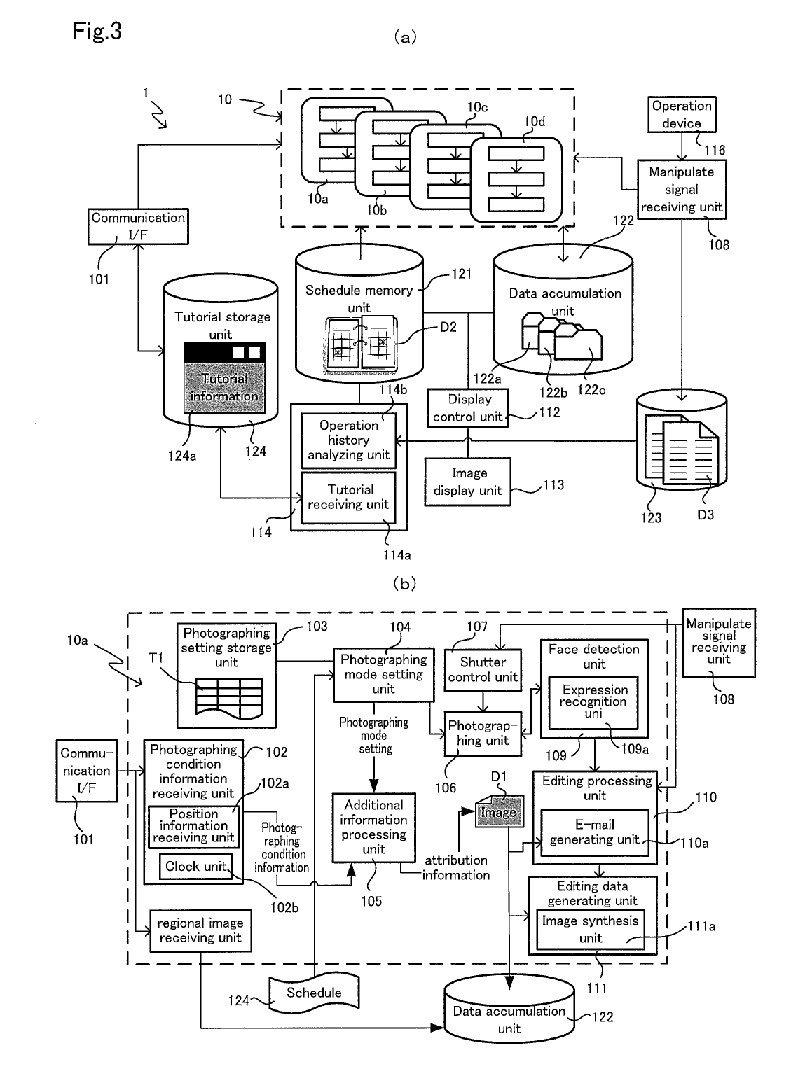

FIG. 3 (a) is a block diagram showing an internal configuration related to the schedule function and the tutorial function of the personal digital assistant 1. Moreover, in the context of this document, the term “module” is intended to encompass any function unit capable of performing necessary operation, as implemented with hardware such as a device or an apparatus, software capable of performing the functionality of the hardware, or any combination thereof.

The personal digital assistant 1 is provided with a schedule memory unit 121, a data accumulation unit 122, an operation history recording unit 123, a tutorial storage unit 124, and a tutorial setting unit 114 as a module of the schedule system and the tutorial system.

The data accumulation unit 122 is memory storage which stores up the various data, The taken image data D1, the data for processing acquired from the contents server 3, the composite image data with which it was mixed of these, the editing data (for example, face seal) which processed it into each image data D1, etc. are stored up.

In this data accumulation unit 122, the image data D1 is distributed and stored in a plurality of folder 122 a-c according to the attribution information (tag information) added by the additional information processing unit 105.

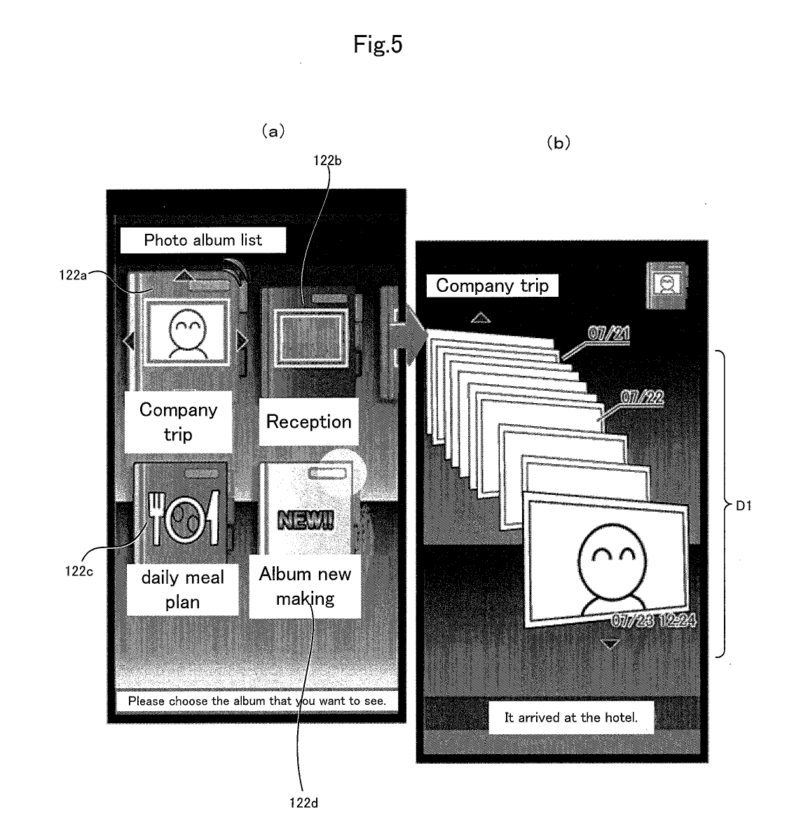

About this folder 122 a-c, as shown in FIG. 5 (a), the folder icon like the photograph album is displayed in order to store the image data according to the theme, as shown in FIG. 5 (b), the image data stored in the folder can be browse by clicking the any folders. And as for browsing the image data, in addition to displaying order by folder, it is possible to browse related images picked up by referring attribution information (tag information) as a keyword for searching for same and similar attribution information. On the other hand, by way of the display type for browsing images, it is possible to display downsized image data by low resolution for small data volume as thumbnails.

This photograph album is a view which classified the picture automatically according to tag information, and each picture is classified according to each attribute of picture included in tag information. In addition, the same picture seems to be stored in a plurality of folders (album), because same image data are repeatedly classified over a plurality of albums by the number of the tag information.

As a kind of this photograph album, it can classify by the item in the tag information, for example, pictures taken during the category (“travel” etc.) of the schedule can be collected, pictures can be collected by each photographing mode (kind of camera), pictures can be collected by the person in the picture, or by his attributes (for example, “family” etc.), and pictures can be collected by date (specific dates, such as the birthday) in the calendar.

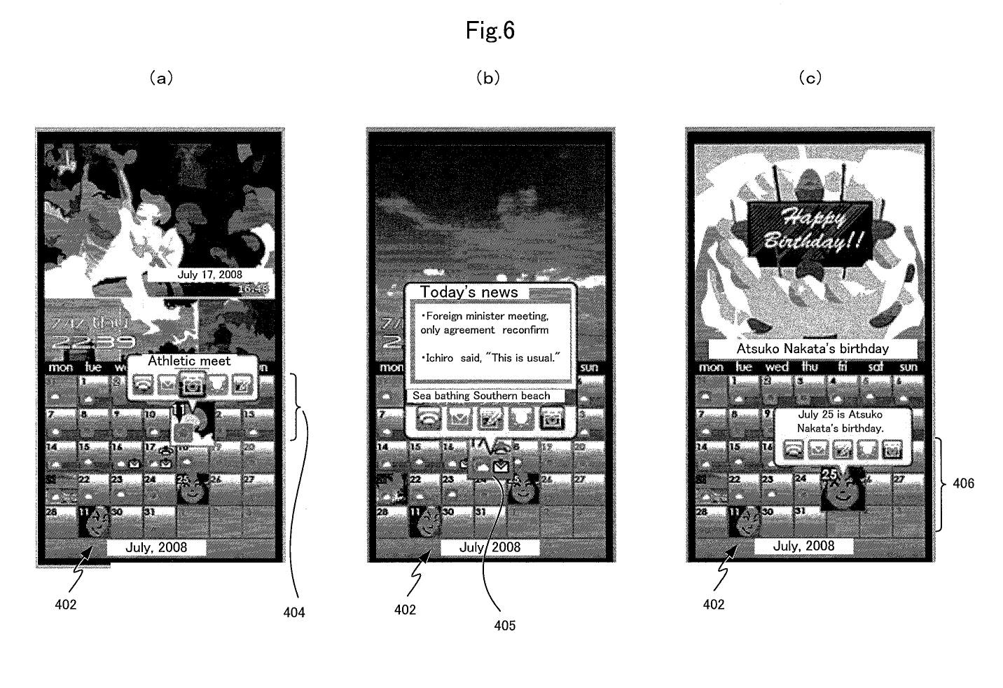

The schedule memory unit 121 is a memory storage which stores the position information, the time information, and the schedule type about the user's schedule as the schedule information D2. This schedule information can be customized by each user, and is displayed on calendar UI402 as shown in FIG. 6(a)-(c). In detail, calendar UI402 of the display control unit 112 is a calendar display function for showing the current date, it splits the calendar by the current date, displays a list of the image data D1 stored in the image data accumulating unit 122 in the split part 404 of the past from the current date, displays a schedule information stored in the schedule memory unit 121 in the split part 406 of the future from the current date.

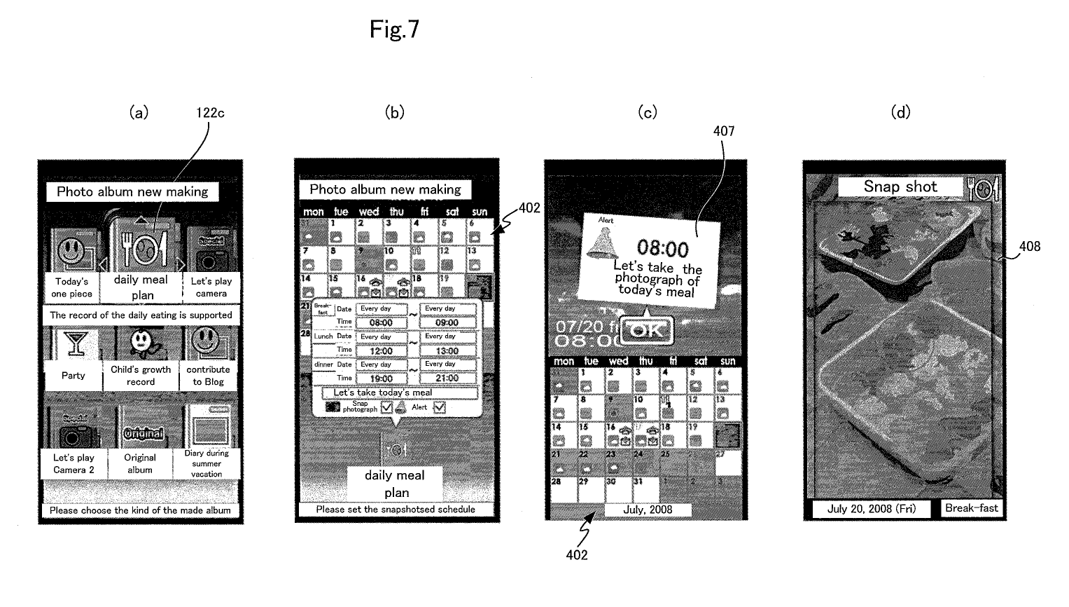

In addition, as shown in FIG. 6 for this schedule information D2, for example, if the user has a “daily meal plan” to report the daily meal with the image data, as shown in FIG. 7 (a), the folder 122c about the plan can be made. As to this folder 122c, as shown in FIG. 7 (b), the snap photographing mode related with the 3 times of daily mealtime zones and house location information are recorded on the mode setting table T1. And when it arrives at the time and the place recorded on the schedule, the pop up message 407 as shown in FIG. 7 (c) is displayed, the mode setting table T1 is read automatically, and as shown in FIG. 7 (d) photographing mode suitable for the snap shot of the meal is set up.

The tutorial storage unit 124 is a memory storage which relates the information about the example of how to use of photographing mode with location information and time information, and stores them as the tutorial information 124a. In the case of the present embodiment, this tutorial stored in Tutorial storage unit 124 is the teaching materials for explaining how to use about the photographing function, etc., and is contents data including the animation, the still picture, the writing text, and the script for executing each functional module of the personal digital assistant 1 (program).

As this tutorial, the explanation about the function of recommendation and the display of the information data (recommendation research) distributed from the Internet in addition to the information about the example of how to use of photographing mode is included. As this recommendation research function, for example, and may measure the current position by the position information acquiring means, such as GPS, and may display the area information of the recommendation spot, store information, gourmet information, the specialty, etc., around the current position. This area information may be the regional information distributed from the contents server 3, and it is preferred to be displayed as ranking by the importance (the degree of recommendation).

As this ranking, picture show record, CD and the number of downloads of the ring tone, television viewership, and the retrieval number may be included.

Further, this tutorial may select the function suitable for the situation according to the contents (the place, the date, and the contents of the event) of the schedule registered into the schedule, and may explain the example of use which recommends it. As the information which tied up with this schedule, the related information data may be collected from the Internet based on the contents of the schedule, and it may display as push information.

This tutorial may recommend using other functions mounted in the personal digital assistant, and may explain the how to use it. For example, the operating procedures, such as the purchase of the ticket, the purchase of goods, and download of contents, are explained by the communication function and browser function with the personal digital assistant. The information about these tickets, and goods and contents may be made to link with the ranking display function, and may be displayed as a result of the recommendation research.

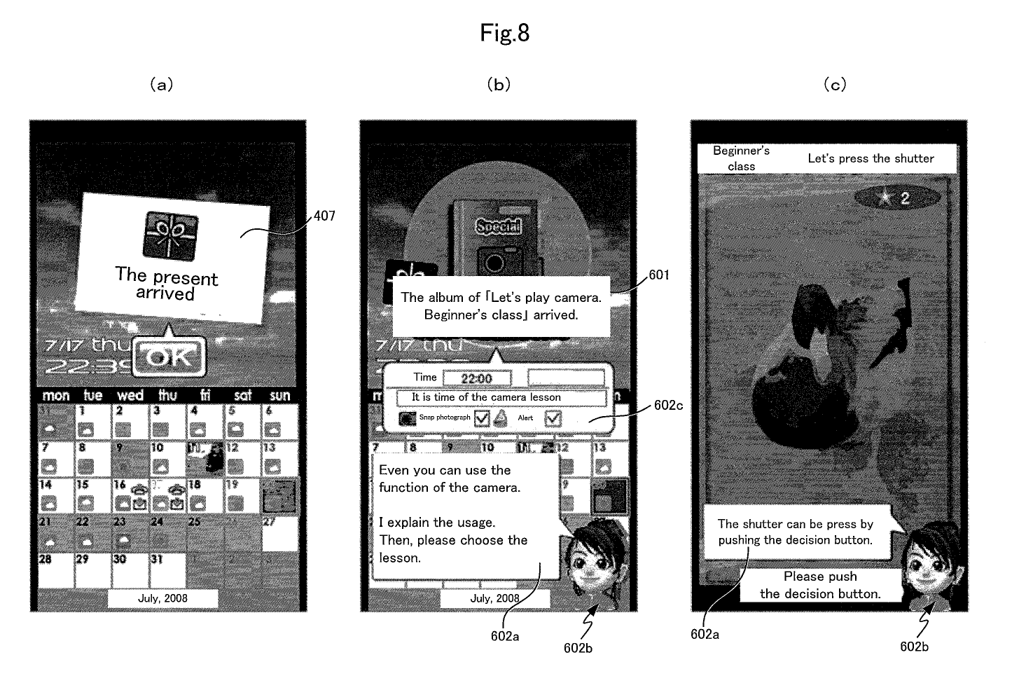

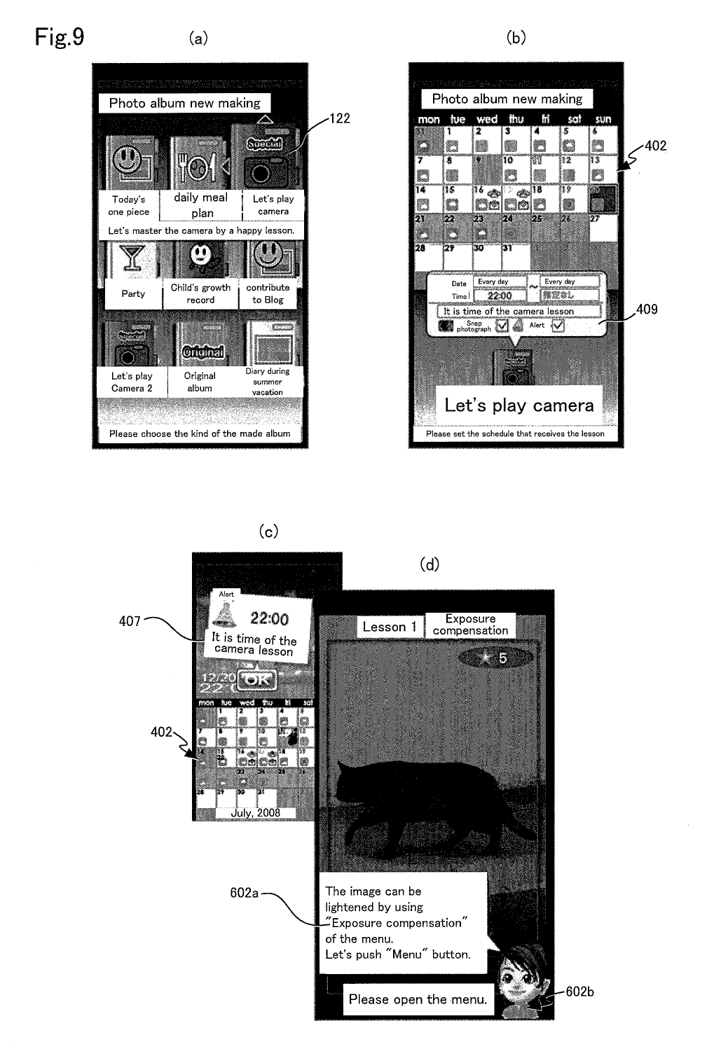

In the case of the present embodiment, when the script of this tutorial is executed, as shown in FIG. 8 (a) and FIG. 9 (c), the character string is displayed by the pop-up 407, while the guidance 601 by the animation or the still picture and the notice pop up screen 602c of the schedule are displayed, the balloon 602a by the character 602b is expressed, in alphabetic information or voice response, according to the user's response operation, the description of the example of use goes on by the interactive mode.

In addition, when the tutorial is the above recommendation research, the browser function is started automatically, it accesses the local information data which accessed the Internet etc. or was previously stored into the body, and executes displaying of advice of the recommendation function, and explanation and pertinent information (ranking information etc.).

In the example shown in FIG. 8 and FIG. 9, the camera photographing screen is launched with leading the user's manipulation, by displaying tutorial information to urge using of the camera function. Moreover, as shown in FIG. 8, it is the case for example that tutorial information is distributed as a present from the contents server 3 (FIG. 8 (a)), the schedule conforming to the theme “let's play camera” is assembled, and the folder 122 for this tutorial is created by activation of tutorial information (FIG. 9 (a) and FIG. 9 (b)). Guidance of the manipulation by the character 602b is started when the schedule has come (FIG. 8 (b) or FIG. 9 (c)), and the operation lessons of “the volume on camera photographing for beginners' class (FIG. 8 (a))” or “exposure correction (FIG. 9 (d))” is going on by the interactive mode according to the user's response operation.

And the tutorial analyzes the history of user's operation, it will be executed to the unused function, and the execution is set up by the tutorial setting unit 114.

In addition, in execution of the tutorial, the content of the registered schedules are watched periodically, and if the time registered into the schedule comes, the alert of the schedule time will be displayed with explanation of the recommendation function, and the relevant information by recommendation research. Further, at the time of execution of this tutorial, current time and the current position may be acquired from the photographing condition information receiving unit 102, and explanation of the function according to the situations (the time, the place, and etc.) and the relevant information by recommendation research may be displayed.

The tutorial setting unit 114 is a module which adds the location information and time information included in the tutorial information 124a acquired by the tutorial receiving unit 114a, and the type of the schedule according to the example of how to use, to the schedule information as the user's schedule. In the case of the present embodiment, it has the tutorial receiving unit 114a and the operation history analyzing unit 114b. The operation history analyzing unit 114b is a module which analyzes the history of the photographing mode and extracts unused photographing mode. The tutorial receiving unit 114a is the module which acquires the tutorial of the unused photographing mode and the other functions, by referring the tutorial information 124a, based on the unused photographing mode extracted by the operation history analyzing unit 114b, the content of the schedule registered into the schedule 121, and the function according to the situation acquired by the photographing condition information receiving unit 102.

The operation history analyzing unit 114b is a module which analyzes the history of the photographing mode and extracts unused photographing mode. The tutorial receiving unit 114a is a module which acquires the tutorial of the unused photographing mode with reference to the tutorial information 124a based on the unused photographing mode extracted by the operation history analyzing unit 114b.

The operation history recording unit 123 is a memory storage which records the history of the photographing mode set up by the photographing mode setting unit, as the log data D3, the history of the mode setting based on user's operation is stored as the log data D3.

### (Control Method by the Schedule Function and the Tutorial Function)

The operation control method of the present invention can be enforced by operating the schedule function and the tutorial function which has the above composition.

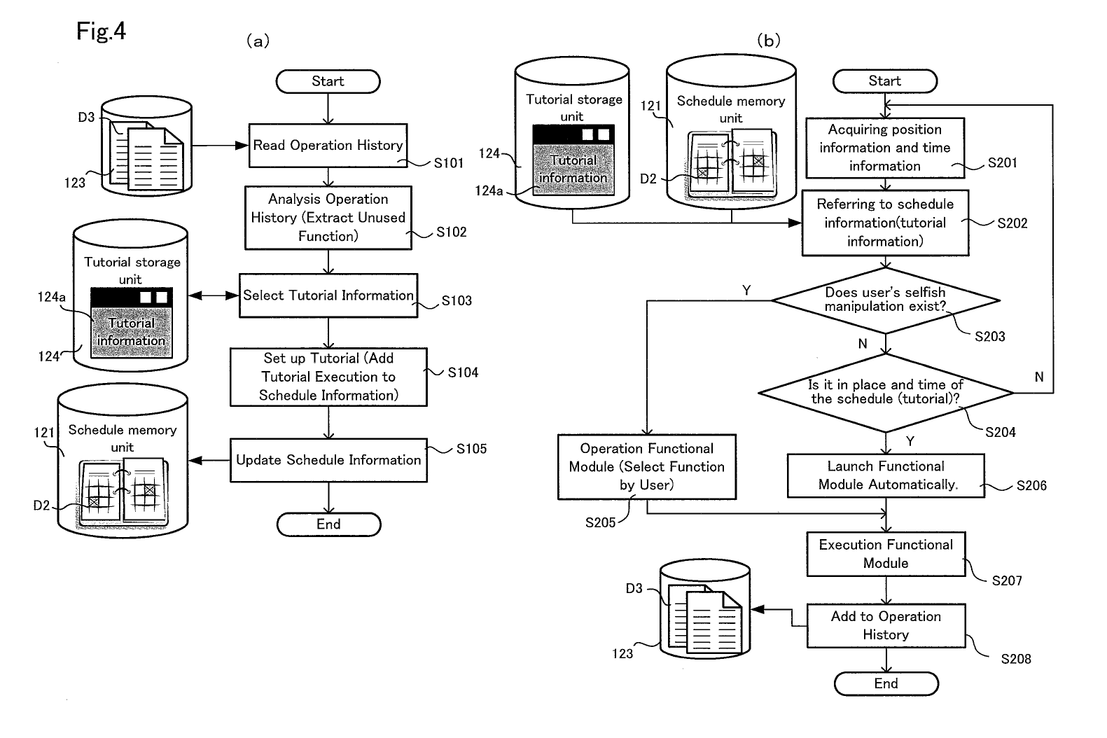

FIG. 4 is a flow chart figure showing operation of the schedule function and the tutorial function related to this embodiment.

To begin with, in setting up the tutorial, as shown in FIG. 4 (a), unused functional modules are extracted periodically. In detail, whenever the user uses one of the functional modules, the log data D3 of the used functional module is recorded serially, and the stored log data D3 is read from the operation history record unit 123 (S101), and analysis of the operation history is executed (S102).

Next, the example of how to use of the unused functional module is selected, with referring tutorial information based on the unused functional module extracted at Step S102 (S103). And the location information, the time information, and the schedule content type according to the example of using which are included in tutorial information selected at Step S103 are added to the schedule information D2 as the user's schedule (S104). In addition, in the case of the present embodiment, the tutorial information is related with own location information, in the tutorial setting step, time information, location information, and schedule content type about the user's schedule are added as the schedule information D2.

Then, the schedule information D2 is updated (S105). As shown in FIG. 8 (a), this updated schedule information D2 can be displayed as the list in calendar UI with the icon display according to the attribution information of each picture. In detail, in this calendar display, it splits the calendar by the current date, displays a list of the image data D1 stored in the image data accumulating unit 122 in the split part of the past from the current date, displays a schedule information stored in the schedule memory unit 121 in the split part of the future from the current date.

And the tutorial set up in this way, will be included and executed in the user's schedule as follows. FIG. 4 (b) is a flow chart showing the procedure of the operation control by the schedule (tutorial).

To begin with, while acquiring the own location information and the current time information periodically by loop processing (S201 and S202), with reference to the schedule information D2, checking whether it is in the place and time as the schedule, or at unexpected place and time, checking whether the user started the handling selfish (S203 and S204). It follows, it will be in the waiting state until the user operates it, or until required time comes (“N” in S203 and S204).

In addition here,

The tutorial for the unused functional module is set up as a schedule, the schedule of the tutorial start of the operation lessons is included in the schedule of this step S204. That is, to the tutorial information 124a, the information about the example of how to use of the photographing mode relates with location information and time information, and is memorized, by adding the location information, the time information and the type of the schedule according to the example of how to use included in this tutorial information 124a, to the schedule information as the user's schedule, the operation lessons of unused photographing mode will be scheduled as the user's plan.

And in case the user starts photographing operation selfish, before the time of the schedule came (“Y” in S203), the shot is executed by the photographing mode selected by the user (S205 and S207), and the photographing mode is added to the log data D3 (S208).

On the other hand, in Step S204, when the scheduled place and time arrive (“Y” in Step S204), and the unused functional module will be started automatically, and the example of how to use of the functional modules will be informed based on schedule information, and to use the unused functional module will be recommended (S206).

And if an operation to the functional module is done, and executed (S207), and its operation history are added to the log data D3 (S208).

### (Picture Photographing Function)

The personal digital assistant 1 has many functional modules, and it has the picture photographing function as one of this multifunction module. FIG. 3 (b) is the block diagram showing the module of the picture photographing system.

As shown in FIG. 3 (b), in detail, the module of the picture photographing system is provided with a photographing unit 106, a shutter control unit 107, a face detection unit 109, a photographing mode setting unit 104, an additional information processing unit 105, a photographing condition information receiving unit 102, a photographing setting storage unit 103, and a data accumulation unit 122.

The photographing unit 106 is a module which takes the digital image optically, executes photographing processing according to the control from the shutter control unit 107, and stores up the taken picture in the data accumulation unit 122 as the image data D1. In addition, although the shutter control unit 107 executes a photographing processing with the manipulate signal based on the user's operation inputted from the operation device via the manipulate signal receiving unit 108, for example, it is possible to add an automatic photographing mode which executes a photographing processing automatically at the moment of the expression recognition unit 109a in the face detection unit 109 has recognized differential expression, such as the smiling face of the object.

The additional information processing unit 105 is a module which adds attribution information to the image data D1 taken by the photographing unit 106 as tag information, and adds a photographing mode setting when the image data D1 acquired from the photographing mode setting unit 104 is taken, and the photographing condition information (position information, time, etc.) acquired from the photographing condition information receiving unit 102 as attribution information about the facts of each image data D1. For adding this tag information, there is the way to store it directly in the image data D1, or the way to store it in another file data such as the management data (metadata) related with the image data D1.

In addition, the content (the place, the participant, the content of the event) of the schedule according to the photographing time and the attribution information of the taken image data can be related and recorded on this tag information. Further, the face of the person reflected to the picture is recognized, and it is possible to include the feature of the face in this tag information. For example, after the person specifies by referring to the face seal (face photograph information) which are set as the address book, the feature of the face may be related with the specified information, and may be recorded in the address book etc.

In addition, in case of this facial recognition, expression, such as the smiling face, is recognized and the recognized expression can be included in the tag information.

In this case, for example, by classifying the picture taken by recognition of the smiling face, the album collected the pictures of the smiling face, will be generated automatically based on the tag information of the “smile.”

In addition, this tag information can be displayed in a list for each picture, can be edited like a modification, deletion, and addition by user's operation. And the attribution information included in tag information is applicable to an album classification of the pictures, an e-mail automatic generation for attaching and sending to the E-mail, etc.

The photographing mode setting unit 104 is a module which sets up the photographing mode of photography by the photographing unit 106. As this photographing mode, there is setting of shutter speed, exposure (iris) and the focal length, the necessity of the flash, the filter, etc., in detail, it has a portrait mode (with adjusting the iris, and a little shading off the background so that the person may be looked nice), a scenery mode (with adjusting a focus equally from the short distance to the long distance, the commemorative photos with a plurality of objects are included), a close-up mode (with close up to the objects), a sport mode (by the high speed shutter: continuous shooting etc. are included), night view portrait modes (for example a person photography in the night view as the background, with adjusting a shutter speed and an iris, to the light volume of the narrow area like a center object), strobe light inhibit mode (photography in the open air) etc. And setting of image size, and image quality (resolution) and the preservation destinations (the body or the archive medium) is included in basic setting included in this photographing mode.

In addition, with this photographing mode, in order to make the user's understanding easy, for example, the suitable selection (put together) pattern of photographing settings and functions may be displayed as a kind of camera, and the user may be made to select them.

For example, a mode in which the user can set up all the photographing functions mounted self can be displayed as a “dainty pro camera”, a mode in which photography by high sensitivity setting in night or at indoor can be displayed as a “high sensitivity camera”, a mode in which attach the frame or the character and the drawing are added to the picture after photography with the function which amends the skin-colored can be displayed as a “Print Club camera”, a mode which transforming the taken picture or mixing other pictures can be displayed as a “party camera”, a mode in which effect processing, such as the sepia tone, the oil painting touch and the suspected fish-eye lens, and the filter effect, can be displayed as a “art camera”, a mode in which image analyses, such as analysis of the two dimensions bar code or QR Code, character recognition functions, such as OCR, the facial recognition function, can be displayed as a “search camera”, and the mode in which taking of movies and uploading the taken movies/pictures can be displayed as a “video camera.”

As other photographing modes, the mode which addition comments to the taken pictures, and uploading to the Web site on the Internet can be displayed as a “blog camera”, as the mode for making the attention to the camera of the animal by outputting the voice of the animals, such as a dog and a cat can be displayed as a “the pet camera”, a mode adjusting a short-distance shot for a still lives, such as foods can be displayed as the “cooking camera.”

In addition, in case of the reference the mode settings, the above photographing mode setting unit 104 can adjust setting of the photographing mode to the photographing unit 106 based on current time, position information, time information and the classification of the content of the schedule which are included in schedule information, and can also display the message which recommends setting of better photographing mode. For example, if current time is during the travel record on the schedule, the portrait mode is set as the default setting, if it is during the party, the “party camera”, the “Print Club camera”, etc. are set up preferentially, or a message which recommends to use of that is outputted. When in the night time, the above the “high sensitivity camera” may be recommended. Further, with setting of this photographing mode, the message which recommends other functions, such as recommending to use of the regional frame and to use of the navigation function by GPS, may be outputted.

The photographing setting storage units 103 are a memory storage, such as the nonvolatile memory which stores of the table data for selecting the photographing mode according to the place and time, when the photographing mode setting unit 104 sets up photographing mode. In detail, it has stored the table data which related position information and time information, and photographing mode as the mode setting table T1, refers to the mode setting table T1 based on position information and time information according to the request from the photographing mode setting unit 104, and reads the photographing mode which should be used for the shot, and sends it out to the photographing mode setting unit 104. The photographing mode setting unit 104 refers to the mode setting for according to the photographing condition information which the photographing condition information receiving unit 102 acquired, and sets up the referred photographing mode to the photographing unit 106.

In the case of the present embodiment, when taking pictures, the photographing condition information receiving unit 102 has the acquiring positional information unit 102a which acquires the position information which points the own position, and the clock part 102b which acquires the current time information as photographing condition information, at the time of completing of the shot, and inputs each data acquired from the acquiring positional information unit 102a and the clock part 102b as photographing condition information into the additional information processing unit 105, responds to the request from the additional information processing unit 105.

The acquiring positional information unit 102a is a module which acquires and records the position information which points the own position when the shot, for example, it detects the position of the self-opportunity with the signal from the satellite 21 such as GPS, and it detects the position with the radio field intensity from the base transceiver station 22 of the cellular phone, etc. The clock part 102b is a module which measures current time, can manage the time zone according to the position information acquired by the acquiring positional information unit 102a, and can also display the time which considered the time difference etc.

The data accumulation unit 122 is memory storage which stores up the various data, The taken image data D1, the data for processing acquired from the contents server 3, the composite image data with which it was mixed of these, the editing data (for example, face seal) which processed it into each image data D1, etc. are stored up.

In this data accumulation unit 122, the image data D1 is distributed and stored in a plurality of folder 122 a-c according to the attribution information (tag information) added by the additional information processing unit 105. In addition, In the case of the present embodiment, even though it distributes to the folder according to tag information and stored up the picture, the present invention is not limited thereto, but also, the actual storing position is used as the ordinary folders (for example, “My Pictures” etc.) appointed by basic setting, and it is preferred at in the case of the list display or the album display to execute in dummy the distribution based on the tag information added to each picture, and to indicate by the classification.

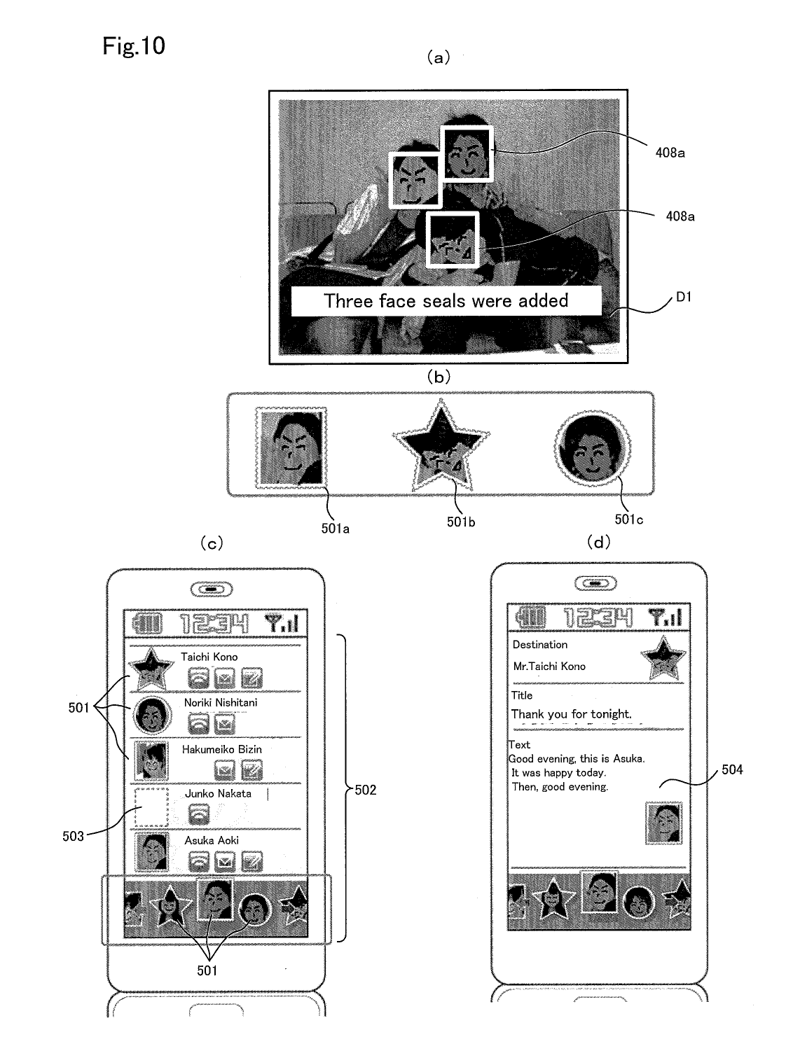

The face detection unit 109 is a module for recognition person's face parts by finding out the specified geometric shape formed of the eyes, the nose, the mouth, etc., and computes the coordinate's position of the detected face part in base images. This face detection processing is started before photographing operation, as shown in FIG. 10 (a), on the finder image plane, the recognized face is emphasized by the marking 408a, moves together the automatic focusing function for measuring the distance to the object and focusing according to the distance.

This face detection unit 109 has the expression recognition unit 109a which recognizes the specified expression such as the smiling face of the person who is the target of the shot, and is provided with the function to recognize the face part and its expression in the monitor picture at the shot, and to input the recognized result into the shutter control unit 107. The shutter control unit 107 inputs the control signal which makes the photographing unit 106 execute shutter operation according to the inputted recognizing result. By containing the information about the feature and expression of the face which have been recognized by this Face detection unit 109 and expression recognition unit 109a to the tag information, each picture can be classified according to the person in the picture, or can be classified according to the type of expression. About the feature of the face, for example, the person may be specified by comparing the face seal registered into the address book.

The personal digital assistant 1 is provided with an editing processing unit 110 and an editing data generating unit 111 as a module of the editing processing system.

The editing processing unit 110 is a module which executes various editing processing according to the operator's handling, can execute the image synthesizing process which composes the pictures, such as the frame image and the background image, to the taken base images in addition to photo retouch processing which adds the drawing on the picture with the touch pen etc., or fills in the character etc. in conjunction with GUI. This editing processing unit 110 is provided also with the function to display the list of the tag information linked with each picture, and to edit it by addition, deletion, modification, etc.

In addition, this editing processing unit 110 is provided also with E-mail generating unit 110a which generates the E-mail and sends via communication I/F 101. This E-mail generating unit 110a is a function which attaches the picture stored up in the image data accumulating part 122, and the taken picture D1 to the E-mail, and sends it, and can generate automatically the E-mail include a necessary information based on the tag information of the image data. For example, the function recognizes the person contained by tag information from the picture, searches the person from the address book, and fills the mail address and person's name found out from the address book into the E-mail as a destination address automatically. In addition, the function generates the text by extracting the place, date and the details of the event when the picture was taken, from the information contained by tag information or the related schedule information (hysteresis information), and may use the text as the body test and the title of the E-mail.

The E-mail generating unit 110a is provided also with the function which inserts the face seal as a pictorial symbol while editing the mail text. For the function, for example, as for the dictionary conversion function, the face seal insertion function is related with the person's name, and when the person's name is written in the text, it may change to or insert the face seal automatically.

In addition, E-mail generating unit 110a is provided also with the function which inserts the content of the schedule to the E-mail automatically in the case of generating an E-mail. For example, the function searches the address book using the name of the person related to the schedule written on the schedule, and fills in the person's mail address as an address, and makes the title and the body text of the E-mail by using the content of the selected event from the schedule.

The editing data generating unit 111 is a module which generates the editing data which is the result of the editing operation by the editing processing unit 110, and the generated data is stored in the data accumulation unit 122. This editing data generating unit 111 also stores up an edited image data into the data accumulation unit 122, with the tag information relevant to it. The editing data generating unit 111 is provided with the image synthesis unit 111a, this image synthesis unit 111a sets up the picture taken by the photographing unit 106 as the base images D11, and composes other image data D12 and the base images D11. The compositing process by this image synthesis unit 111a is also controllable by the editing operation to the above editing processing unit 110.

In addition, this image synthesis unit 111a is provided with the function as a face seal generating unit which changes the face part detected by the face detection unit 109 to face seal which is the specific-shaped image data. These face seals 501 a-c are created as icon image data of various shape as shown in FIG. 10 (b), for example, by composing the image data of the stuffed-animal suit with base images, or by cutting the picture, after setting the coordinates position of the face part which the face detection unit 109 detected as the reference position. Moreover, generation processing of this face seal is automatically executed, when the face detection unit 109 has recognized the face part, in default configuration. In addition, the user can also create the face seal manually purposely, moreover, whenever the face part is taken, the face seal is created and stored automatically.

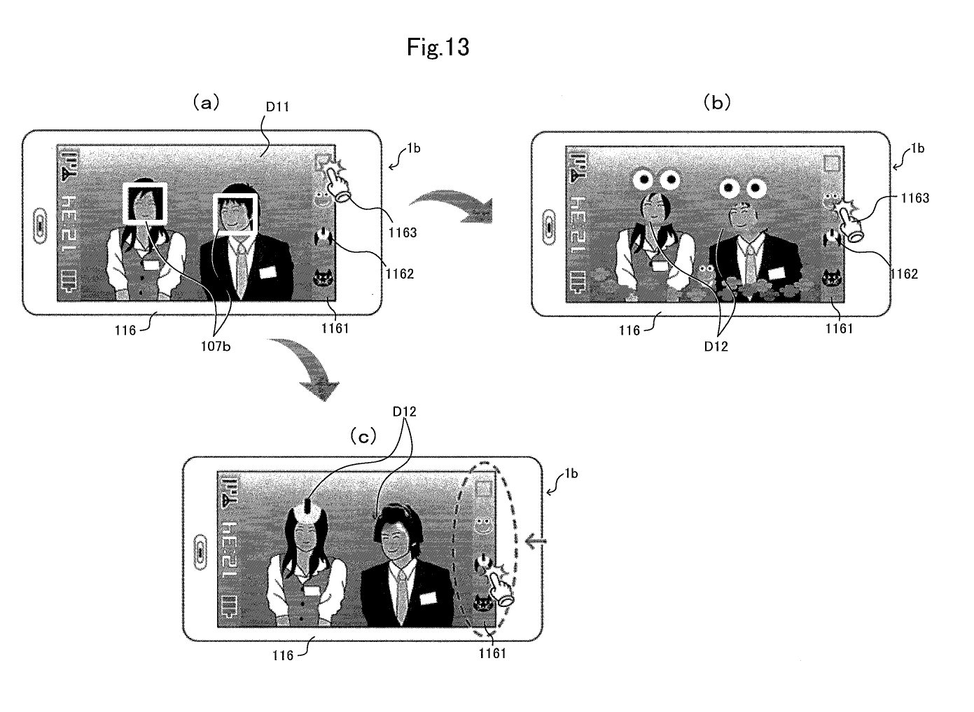

In addition, making of this face seal is faced, as shown in FIG. 13 (a)-(c), image synthesis unit 111a, may compose the added picture which signifies the character of the region according to position information to the taken base images, after setting the coordinates position of the face part detected by the face detection unit 109 as the reference position. These added pictures may be previously installed in the personal digital assistant 1, and may be stored at it, and may be downloaded from the contents server 3.

Moreover, the face seal created by this image synthesis unit 111a can be related with the person registered into the address book, and can be stored, thereby the person's face seal can be used for the manipulation and data relevant to each one. For example, the face seal can be displayed as an index of the address book, or can be icon displayed as an index of the photograph album. In addition, this face seal can also be used as a pictorial symbol signifying each one, when creating the E-mail, if the person name registered into the address book is written in the E-mail, the person name is detected automatically and it may be made to add the face seal in the text.

As the module of the user interface system, the personal digital assistant 1 is provided with a manipulate signal receiving unit 108, a display control unit 112, an image display part 113.

The manipulate signal receiving unit 108 is a module which acquires the manipulate signal from the operation device based on user's operation, and inputs the executive instruction according to the manipulate signal into Shutter control unit 107 or the editing processing part 110. At this point, as this operation device, the touch panel, the manual operation button, the acceleration sensor, etc. are included. This manipulate signal is sent out to each module as the operation target, is sent out to the operation history recording unit 123, and is stored as the log data D3.

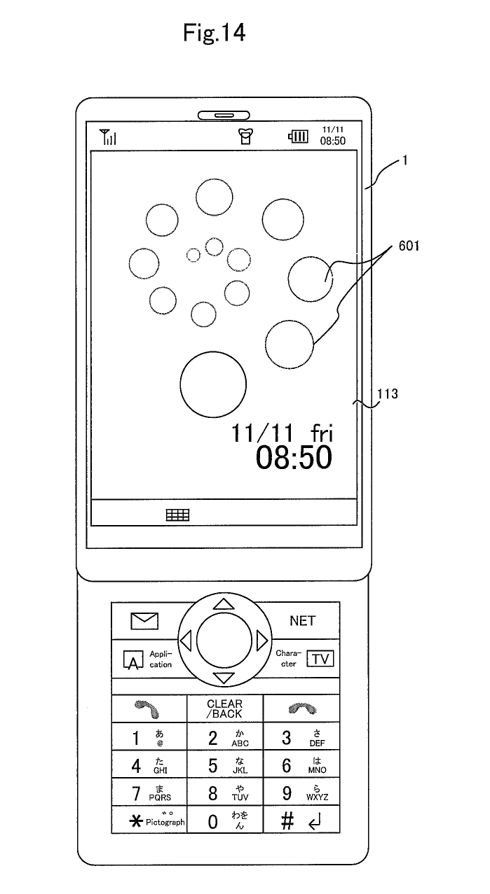

The display control unit 112 is a module which creates the image data for displaying on the image display part 113 as GUI, when in taking pictures, it displays the finder image caught by the photographing unit 106, and when in editing the picture, it displays change of the pictures, such as the icon based on the user's operation signal acquired by the manipulate signal receiving unit 108. Moreover, as the way of the icon display by this display control unit 112, as shown in FIG. 14, arranging the icons 601 in spiral pattern (swirl) on the image display part 113, it is possible to make the spiral pattern right-handed rotation or left-handed rotation by the user's rotating operation, in order to make them move with expanding or reducing the size, for example, the icons are made moving to outside from the center with expanding size, or the icons are made moving to the center from outside with contracting size.

For the user's rotating operation, for example, providing the rotating wheel part in the portable telephone body as hardware, or detecting a rotating action of the point mark on the touch panel as the user's operation.

The display control unit 112 is provided with the slide show function which plays back pictures stored in the image data accumulating part 122 order by and continuous in order and continuously. In this slide show function, it is possible to play back order by photograph album, and various rendering can be carried out when playing back this slide show.

In this slide show rendering, for example, it is possible to display together with the information relevant to a tag information (photographing location, photographing time, photographing mode, the schedule of the time, and the regional information about the location, etc.), by comparing the tag information used as the basis of the classification of the photograph album. In detail, when the photograph album is related to the travel, the moving track based on the regional information on the travel destination, the map, and the navigation history, etc. may be displayed as an introduction of the slide show. And also it is possible to make the display order of the picture in the slide show by photographing time, and it is possible to execute produce according to photographing mode, for example, when photographing mode is the Print Club camera, frames of the slide show is changed like the Print Club note.

In addition, the display control unit 112 in this embodiment is provided with the function which displays the attribution information of the data stored in the data accumulation unit 122 as the face seals 501a-501c. For example, in case the person in the picture taken by the camera is recorded as attribution information (tag information), the face seal is displayed as an icon for signifying the person.

Relation of this tag information and the face seal, for example, it is possible to use the data in the address book. Accordingly, it sets up on the person registered into the address book, and the taken image and the face seal are matched and recorded for the person.

In addition, the display control unit 112 is provided also with the function which searches and reads out the data stored into the data accumulation unit 122, the corresponding data can be read by operation selection on calendar UI on GUI, or e-mail browsing UI (FIG. 10 (c) and (d)).

Moreover,

in the photographing mode setting unit 104, it is selectable a photographing mode including the facial recognition processing by the face detection unit 109 and the conversion process of the image data based on the face seal generating unit, and the operation history recording unit 123 also records an operation history of photographing mode including the detection processing and the conversion process selected by the photographing mode setting unit 104, with the operation history.

### (Image Photographing System Method)

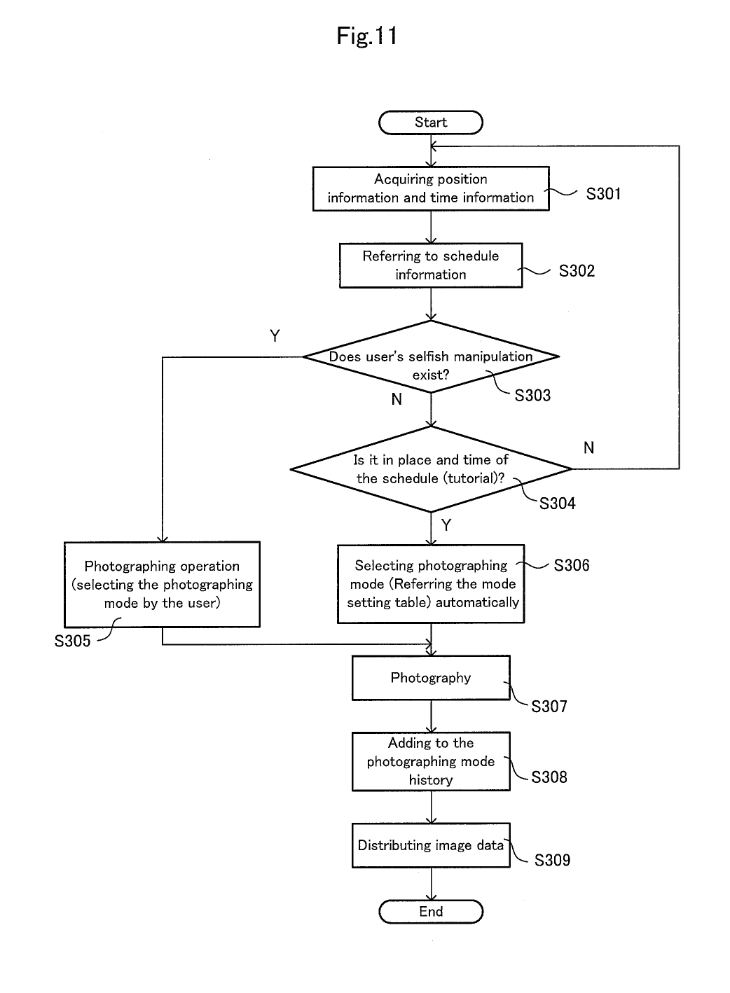

The image photographing system method of this embodiment can be enforced by operating the image photographing function which has the above composition. FIG. 11 is the flow chart figure showing operation of the image photographing system related to this embodiment.

To begin with, while acquiring the own location information and the current time information periodically by loop processing (S301 and S302), with reference to the schedule information D2, checking whether it is in the place and time as the schedule, or at unexpected place and time, checking whether the user started the handling selfish (S303 and S304). It follows, it will be in the waiting state until the user operates it, or until required time comes (“N” in S303 and S304).

In addition, the schedule in this step S304 may be the starting time of the tutorial for the lesson operation mentioned above. That is, to the tutorial information 124a, the information about the example of how to use of the photographing mode relates with location information and time information, and is memorized, by adding the location information, the time information and the type of the schedule according to the example of how to use included in this tutorial information 124a, to the schedule information as the user's schedule, the operation lessons of unused photographing mode will be scheduled as the user's plan.

And in case the user starts photographing operation selfish, before the time of the schedule came (“Y” in S303), the shot is executed by the photographing mode selected by the user (S305 and S307), and the photographing mode is added to the log data D3 (S308). In addition, in the case of the present embodiment, previously, the table data relates the location information the time information, and the photographing mode is store into the photographing setting storage unit 103 as the photographing mode setting T1, in the photographing mode setting step (S305), according to the photographing condition information acquired by the photographing condition information acquiring step (S301), the mode setting T1 is referred and the referred photographing mode T1 is set up to the photographing unit 106.

On the other hand, in Step S304, when the scheduled place and time arrive (“Y” in Step S304), photographing operation is urged by selecting photographing mode automatically (S306), if photographing operation is executed (S307), and its photographing mode are added to the log data D3 (S308). In addition, the location information, the time information, and the type of the schedule about the user's schedule are recorded on schedule information, in the photographing mode setting step (S306), when mode setting is referred, the photographing mode to the photographing unit is set up, based on the location information, the time information, and the type the schedule included in the schedule information D2. Since the content of the schedule, for example, like the “birthday” and “traveling abroad” is recorded in the schedule information D2, more exact photographing mode can be set up by using the type of the content of the schedule as a keyword.

And according to attribution information including the place, time, and photographing mode of the shot, the image data D1 will be distributed and stored into each folder 122 a-c of the data accumulation unit 122. The image data D1 stored in each of this folder 122 a-c can be displayed as the list in calendar UI with the icon display according to the attribution information of each picture. In detail, in this calendar display, it splits the calendar by the current date, displays a list of the image data D1 stored in the image data accumulating unit 122 in the split part of the past from the current date, displays a schedule information stored in the schedule memory unit 121 in the split part of the future from the current date. As shown in FIG. 15 for a display of this calendar and schedule, the icons 601 as date of the calendar are arranged spirally, the spiral display may be moved forward or backed off by the user's rotation operation, and the display range may be changed.

In addition, by this shot, the face seal will be generated by changing the person's face part into the image data of specific shape, this face seal can be freely pasted in calendar UI as an icon image.

The face seal can be related with the tag information of the picture, the address book, the schedule, etc. For example, it is possible to relate with the attribution information of the taken image data, and the content (the place, the participant, the content of the event) of the schedule according to the photographing time, and it possible to record them on tag information. Further, by recognizing the face of the person in the picture, the feature of the face can be included in this tag information. About the feature of this face, for example, by referring the face seal set in the address book, the person can be specified, and it can be related with the address book and can also be recorded. In addition, in case of this facial recognition, expression, such as the smiling face, is recognized and the recognized expression can be included in the tag information. In this case, for example, by classifying the picture taken by recognition of the smiling face, the album collected the pictures of the smiling face, will be generated automatically based on the tag information of the “smile.”

### (Image Composing Photographing Method)

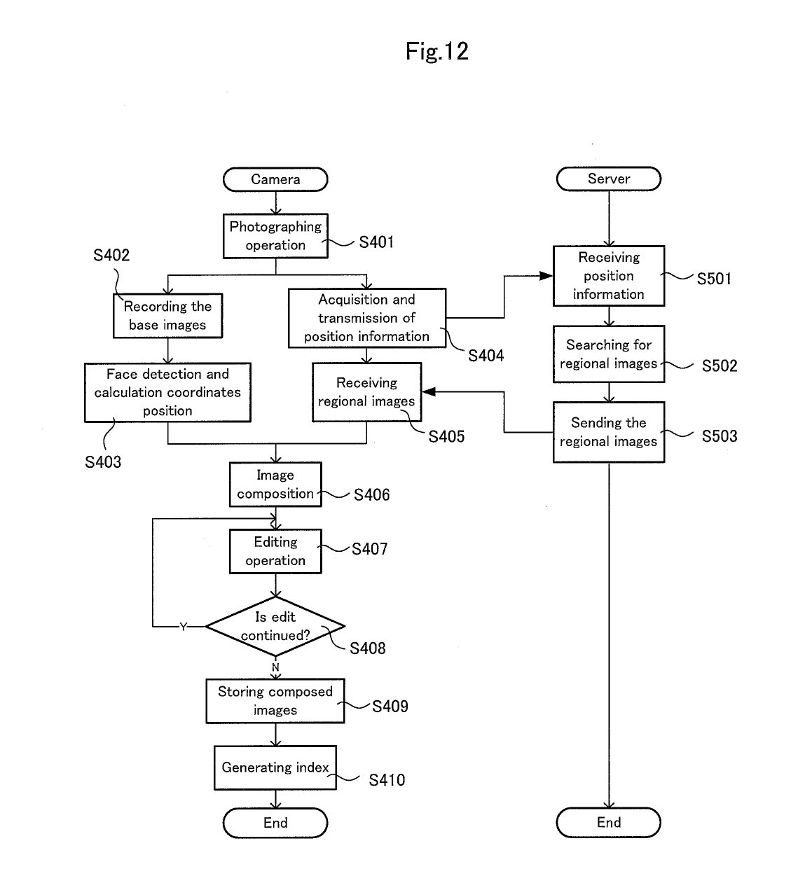

Further, the image synthesis unit 111a downloads an indigenous attached data in the specific region by the data transmission and reception with the contents server 3, and, is provided with the function which composes the indigenous image data in the specific region to the image data of the face seal. FIG. 12 is the flow chart figure showing the operation of the image synthesis unit 111a related to this embodiment.

First, the image is taken by the photographing unit 106 (S401). When taking a photograph, in the case of the present embodiment, “automatic photographing mode” which always watches the finder image by the photographing unit 106 may be executed.

With this mode, in the finder image taken by the photographing unit 106, by the expression recognition unit 109a performs the expression recognition for recognizing a specified expression, for example, such a person's smiling face as a target for photography, and at the moment of recognizing the smiling face, photographing processing is executed automatically. In Step S401, the image data taken by the photographing unit 106 is recorded on the data accumulation unit 122 as base images (S402), and face detection is performed to base images (S403). When in this detection of face part, the face detection unit 109 computes the coordinates position in the base images of the detected face part.

In addition, by this photographing operation, and while the own position information at the time of photography is acquired and recorded, this position information is sent to the contents server 3 (S404). With the contents server 3 which received this position information (S501), based on the position information at the time of the received photography, the regional image data related with position information is searched for from the regional image storage database (S502), and the selected image is replied (S503). In addition, if regional image data is previously installed in the personal digital assistant 1 and is stored in the personal digital assistant 1, it is not necessary to distribute the regional image data from this contents server 3. It follows, in the step S404 and S501-503, the personal digital assistant 1 searches for the contents data in the local, and if it does not store in the local, then the steps may be executed.

The “recommended information” which carried out ranking of the topics (places of interest, the specialty, store information, other news) about the region in addition to the above regional image data as contents unique with the every place region distributed from this contents server 3, and the map data are included, and these information are useful to the tutorial, the photograph album of the taken image, and the rendering of the slide show by image restoration, etc.

The camera side which received regional image data, or read the data in the local (S405), and acquired regional image data composes the acquired regional image data D12 to and the base images D11 (S406). In case of this picture composition, the image synthesis unit 111a is composite of the region image data D12 to the base images D11 based on the coordinates position of the face part found out by the face detection unit 109. This composite edit can be operated with the operation devices 116, such as GUI and the ten key, as shown in FIG. 13, in the case of the present embodiment, while the base images D11 related to the shot (or edit) are displayed on GUI, a plurality of icons 1162 of the acquired region image data are listed in the icon area 1161, the region image data D12 for composition can be selected by clicking on these icons 1162, for example with the pointer 1163.

Thus, the editing operation such as other photo retouch processing can be done to the stored image data taken or edited (S407). If editing work is completed (“N” in S408), then the edited image data will be stored (S409).

When storing this image data, in the case of the present embodiment, it is related with location information and stored in the data accumulation unit 122. Then the location information of the stored pictures are generated as index information data (tag information) (S410), and are displayed as icons on GUI. And, by selecting the index (tag information) displayed on GUI, it is possible to search, to read or to start the selected picture, the related data, or the program can be searched from the data accumulation unit 122. Thus, in GUI, it is possible to read and to browse the generated face seal, by selection operation, such as touch operation to the index icon.

(The Operation and Effect in this Embodiment)

According to the embodiment explained above, since the different guidance and operation explanation about unused photographing mode for each user are added to the schedule as the information about the example of how to use operation description, the operation lessons of ignorance or the unknown photographing function for the user can be scheduled as the user's plan. As a result, in the suitable time zone, the tutorial mode is started automatically, and he can recommend using the unused function to the user.

In the case of the present embodiment, since calendar UI is split by dividing line on the current date, displays a list of the image data D1 stored in the image data accumulating unit in the split part of the past from the current date, and displays a schedule information stored in the schedule memory unit in the split part of the future from the current date, about the past, it is possible to have the function as the diaries with the images data D1 for each date, and about the future, it is available to record and display the user's schedule, and it is possible to have the schedule function as a notebook. And since these displays are unified into the one calendar with dividing line on the current date, the GUI for the diary and the notebook can be summarized to one, the area for the display can be reduced with raising clearness, and the limited area for the display can be utilized effectively.

In the case of the present embodiment, the face of the person in the images taken by the user are detected partially, and since can be stored as useful face seals for the icon, each user can use the person's face part for various purposes. Further, because photographing mode including the detection processing and the conversion process is also memorized to the photographing setting storage unit, the automatic setup of the photographing mode at the time of photography and the unused tutorial setup are also attained.

### Modification Example

With the above embodiment, even though the recording and analyzing of the operation history, and storing and selecting the tutorial information are executed on the module provided in the user terminal, however, the present invention is not limited thereto, but the tutorial storage unit 124 and the operation history analyzing unit 114b may be provided on the contents server 3 constituted on the Internet 2. In this case, the tutorial acquisition unit 114a by the user terminal acquires the tutorial (example of use) of the unused functional module through the Internet 2 based on the operation history.

In this case, since the position information at the time of photography, time information, etc. can be collected on the server using the operation history about the functional module for each user, the information can be analyzed and various examples of how to use of the unused functional module to each user can be set up, thereby it will be possible to provide the example of how to use of the more suitable unused functional module for the user. Moreover, in order to store the analysis of the operation history, and the contents data for the tutorial on the server, the user's burden can be reduced and memory space can be used effectively.

### REFERENCE SIGNS LIST

D1—Image data
D11—Base images
D12—Region image data
D2—Schedule information
D3—Log data
T1—Mode setting table
1—Personal digital assistant
2—Internet
3—Contents server
21—Satellite
22—Base transceiver station
31—Region image storage unit
102—Photographing condition information receiving unit
102a—Position information receiving unit
102b—Clock unit
103—Photographing setting storage unit
104—Photographing mode setting unit
105—Additional information processing unit
106—Photographing unit
107—Shutter control unit
107b—Face part
108—Manipulate signal receiving unit
109—Face detection unit
109a—Expression recognition unit
110—Editing processing unit
110a—E-mail generating unit
111—Editing data generating unit
111a—Image synthesis unit
112—Display control unit
113—Image display unit
114—Tutorial setting unit
114a—Tutorial receiving unit
114b—Operation history analyzing unit
116—Operation device
121—Schedule memory unit
122—Data accumulation unit
122 a-c—Folder
123—Operation history recording unit
124—Tutorial storage unit
124a—Tutorial information

1. An operation control system for information processing equipments with a plurality of functional modules comprising:
a clock unit for acquiring current time information;
an operation history recording unit for recording operation history of the functional modules;
a tutorial storage unit for memorizing information about an example of how to use the functional modules as tutorial information related with a time information;
an operation history analyzing unit for extracting unused functional modules by analyzing the operation history;
a tutorial receiving unit for acquiring the example of how to use the unused functional modules with referring to the tutorial information based on the unused functional modules extracted by the operation history analyzing unit;
a schedule memory unit for storing the time information, and the type of the user's schedule as schedule information;
a tutorial setting unit for adding the time information and the classification of the contents of the schedule according to the example of how to use, are included in the tutorial information acquired by the tutorial receiving unit to the schedule information as the user's schedule; and
a guide unit for announcing example of how to use for the functional module based on the schedule information.

2. The operation control system for information processing equipment as claimed in claim 1 comprising further,
a position information acquisition unit which acquires the position information which points the own position,
wherein the tutorial storage unit memorizes information about the example of how to use for each of the functional module as tutorial information with the time information and the position information; and
wherein the schedule memory unit stores the time information, the position information and the type of the user's schedule as schedule information.

3. The operation control system for information processing equipment as claimed in claim 1
wherein the tutorial storage unit and the operation history analyzing unit are provided in the server established on the communication network, and
wherein the tutorial acquisition unit has a communication unit for acquiring examples of how to use for the unused functional module based on the operation history through the communication network.

4. The operation control system for information processing equipment as claimed in claim 1 comprising further,
a display control unit has a calendar display function with showing the current date,
wherein the calendar display function splits the calendar by the current date, displays a list of the image data stored in the image data accumulating unit in the split part of the past from the current date, and displays schedule information stored in the schedule memory unit in the split part of the future from the current date.

5. The operation control system for information processing equipment as claimed in claim 1 comprising further:
a photographing unit for taking pictures as one of the functional modules;
a photographing mode setting unit for setting up photographing modes of photography by the photographing unit;
a photographing condition information receiving unit for acquiring the position information which points the current position, and the current time information as a photographing condition information in an event for taking the pictures;
an additional information processing unit for adding the setting of the photographing mode of the image data, and the photographing condition information to the image data took by the photographing unit as attribution information about the each image data;
an image data accumulating unit for storing the image data with the attribution information added by the additional information processing unit; and
a display control unit for list display of the image data stored in the image data accumulating unit according to the attribution information of each picture,
wherein the operation history recording unit records the history of the operational mode set up by the photographing mode setting unit, with including into the operation history.

6. The operation control system for information processing equipment as claimed in claim 1 comprising further:
a face detection unit for detecting a person's face part, and computing the coordinates position in the base images of this detected face part; and
a face seal generating unit for changing the face part detected by the face detection unit, into the image data of specific shape,
wherein the face detection unit and the face seal generating unit are included in the functional modules;
wherein the photographing mode setting unit, it is selectable a photographing mode including the facial recognition processing by the face detection unit and the conversion process of the image data based on the face seal generating unit; and
wherein the operation history recording unit also records an operation history of photographing mode including the detection processing and the conversion process selected by the photographing mode setting unit, with the operation history.

7. An operation control method for information processing equipments with a plurality of functional modules comprising:
a operation history recording step for memorizing information about an example of how to use the functional modules as a tutorial information related with a position information and a time information previously, and for recording operation history of the functional modules;
an operation history analyzing step for extracting unused functional modules by analyzing the operation history;
a tutorial receiving step for acquiring the example of how to use the unused functional modules with referring to the tutorial information based on the unused functional modules extracted by the operation history analyzing step;
a tutorial setting step for adding the time information and the classification of the contents of the schedule according to the example of how to use, are included in the tutorial information acquired by the tutorial receiving step to the schedule information as the user's schedule; and
a starting tutorial step for announcing example of how to use for the functional module based on the schedule information.

8. The operation control method for information processing equipment as claimed in claim 7
wherein, in the tutorial storage unit, information about the example of how to use for each of the functional module as tutorial information with the time information and the position information are memorized into the tutorial storage unit, and
wherein, in the tutorial setting step, the time information, the position information and the type of the user's schedule as schedule information is added.

9. The operation control method for information processing equipment as claimed in claim 7
wherein the tutorial storage unit is provided in a server established on a communication network, and
wherein, in the operation history analysis step or the tutorial acquisition step, examples of how to use for the unused functional module based on the operation history are acquired through the communication network form the server.

10. The operation control method for information processing equipment as claimed in claim 7 comprising further,
a display control step for displaying a list of the schedule information,
wherein the display control step, the current date included in the calendar is shown, the calendar is split by the current date, a list of the image data stored in the image data accumulating unit is displayed in the split part of the past from the current date, and a schedule information stored in the schedule memory unit are displayed in the split part of the future from the current date.

11. The operation control method for information processing equipment as claimed in claim 7 comprising further:
a photographing mode setting step for setting up photographing modes of photography by a photographing unit a as one of the functional modules;
a photographing condition information receiving step for acquiring the position information which points the current position, and the current time information as a photographing condition information in an event for taking the pictures;
a photographing step for taking pictures;
an additional information processing step for adding the setting of the photographing mode of the image data, and the photographing condition information to the image data took in the photographing step as attribution information about the each image data;
an image data accumulating step for storing the image data with the attribution information added in the additional information processing step; and
a display control step for list display of the image data stored in the image data accumulating unit according to the attribution information of each picture.

12. The operation control method for information processing equipment as claimed in claim 11 comprising further,
a step for detecting a person's face part, computing the coordinates position in the base images of this detected face part, and for changing the face part detected by the face detection unit, into the image data of specific shape, before the image data storing step,
wherein, in the photographing mode setting step, it is selectable a photographing mode including the facial recognition processing and the conversion process of the image data, and
wherein, in the operation history recording step, an operation history of photographing mode including the detection processing and the conversion process selected in the photographing mode setting step are recorded with the operation history.
